(19) United States
(12) Patent Application Publication
(10) Pub. No.: US 2008/0315632 A1
(43) Pub. Date: Dec. 25, 2008

(54) Vehicle with an Opening Roof

(75) Inventor: Claudio Ivano Righetti, Torino (IT)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WEBASTO AG, Stockdorf (DE)

(21) Appl. No.: 12/091,715

(22) PCT Filed: Oct. 27, 2006
(86) PCT No.: PCT/DE2006/001908

§ 371 Date: Apr. 25, 2008

(30) Foreign Application Priority Data
Oct. 27, 2005 (DE) 10 2005 051 768.4

(51) Int. Cl. B60J 7/043

(52) U.S. Cl. 296/217

(57) ABSTRACT

The invention relates to a vehicle with an opening roof. The roof is provided with at least one roof piece and a rear piece that are pivotally interconnected and can be moved between a closed position in which the same close a roof opening or a rear opening and a stowed position at the rear end in which the same unblock the openings while being swiveled towards each other by the internal faces thereof. In order to improve functionality, a forward guide and a rearward guide are each disposed on both sides of the vehicle body, the roof piece is mounted on both sides by means of a bearing so as to be movable on the forward guide while being adjustable along the forward guide between the closed position and the stowed position thereof, and the rear piece is mounted on both sides by a swivel bearing located at the bottom edge so as to be movable on the rearward guide, the rear piece being arranged in a rearward position on the guide by means of the swivel bearing thereof when the roof is closed and in a forward position of the guide by means of the swivel bearing thereof when the roof is stowed.

The invention relates to a vehicle with an openable vehicle roof which has at least one roof part and a rear part which are connected pivotably to each other and can be displaced between a closed position, in which they close a roof opening or a rear opening, and a rear stowage position, in which they open up the openings and, by means of their inner sides, are pivoted toward each other.

GB 444 907 has disclosed a vehicle with a vehicle roof of this type which, for closing a roof opening arranged between lateral roof struts, has a rear part containing a rear window, a rear roof part connected pivotably to the rear part, and a flexible, front roof-closing device connected to the rear roof part. When the roof is opened, the rear part and the rear roof part are folded toward each other and accommodate the front roof-closing device between them. During the opening and stowage of the roof, the lower edge of the rear part is shifted forward via a lever device supported on the vehicle so as to reduce the rear excess length of the stowed roof.

DE 40 38 873 A1 discloses a roof of a convertible, which comprises a front roof part and a rear roof part which are connected pivotably to each other via a hinge. The rear roof part which contains a rear window is mounted pivotably at its lower edge on the vehicle body by means of a mounting forming a fulcrum. During the opening and stowing of the roof, the rear roof part is pivoted rearward about its fulcrum into a horizontal stowage position level with the fulcrum while the front roof part is pivoted toward the inner side, which now faces upward, of the rear roof part. According to one refinement, the fulcrum of the rear roof part is guided in lateral guides such that, when the rear roof part is pivoted, it is displaced forward by means of its lower edge. This enables the roof to be stowed in front of the trunk or the trunk cover.

It is the object of the invention to provide a vehicle mentioned at the beginning whose convertible roof or roof which is to be opened has improved functionality.

This object is achieved according to the invention in the case of the abovementioned vehicle in that a front guide and a rear guide are each arranged on both sides of the vehicle body, in that the roof part is mounted displaceably on both sides in each case by means of a bearing on the front guide and can be displaced along the front guide between its closed position and its stowage position, and in that the rear part is mounted displaceably on both sides in each case on the rear guide by means of a pivot mounting on the lower edge side, and, when the roof is closed, is arranged with its pivot mounting in a rear position on the guide and, when the roof is stowed, is arranged with its pivot mounting in a front position of the guide. By means of this design of the vehicle, an openable vehicle roof with a very stable and functionally reliable bearing and guide mechanism is provided, said vehicle roof permitting a generous roof opening. The guides also permit the setting of stable intermediate positions of the roof part and rear part.

Advantageous refinements of the invention are indicated in the subclaims.

The front guide expediently runs downward in its front section along a roof strut arranged laterally next to the roof opening and in its rear section on a roof pillar. The rear guide is preferably arranged essentially in the longitudinal direction of the vehicle and at a lower level in relation to the rear end of the front guide. However, if required, in accordance with the structural and spatial conditions, other arrangements of the guides may also be preferred. The guides are, for example, guide rails, which are fixed or integrated on the inner sides of lateral structural parts of the vehicle or roof side struts.

If the front guide has, at its rear end, a forwardly extending end section, the roof parts and rear parts can be shifted forward in the stowage position such that the stowage position in the vehicle is optimized. Of course, the two guides are coordinated with each other in their arrangement.

According to a preferred design, a tailgate is arranged below the closed rear part, and the stowed roof, in its stowage position, is arranged essentially horizontally above the tailgate, but an inclined arrangement could also be preferred.

The roof can also have at least one additional roof part which, when the roof is closed, is arranged in the roof opening in front of the roof part and can be shifted into a partial opening position above or below the roof part which is therefore the rear roof part. In principle, the number of additional roof parts is not restricted. The additional roof part may be configured in a very wide variety of designs. In particular, the additional roof part is mounted movably on the roof part and is shifted therewith as the roof is stowed. The additional roof part is preferably mounted pivotably on the rear roof part by means of a link device, in particular a four-bar linkage, or displaceably by means of a sliding guide. The roof part and/or the additional roof part may have a transparent cover or glass cover.

In principle, a manual adjustment of the roof is possible, but the roof part or rear roof part or its mounting on the front guide and the rear part or its pivot mounting on the rear guide can preferably be displaced by means of a driving device.

A deployable wind deflector can be arranged in front of the roof opening in order to improve the flow conditions when the roof is open.

The vehicle may have a fastback or a steep back. In principle, any type of vehicle, such as even a station wagon or a sports utility vehicle, may be equipped with said vehicle roof.

The object is also achieved by means of a vehicle with the features of claim 13. Said particularly simply designed roof which is to be opened can be produced cost-effectively and nevertheless provides a high degree of functionality with a stable design. Both types of roof can optionally be fixed on basically similar vehicles.

A vehicle according to the invention is explained in more detail below using exemplary embodiments and with reference to the drawing, in which:

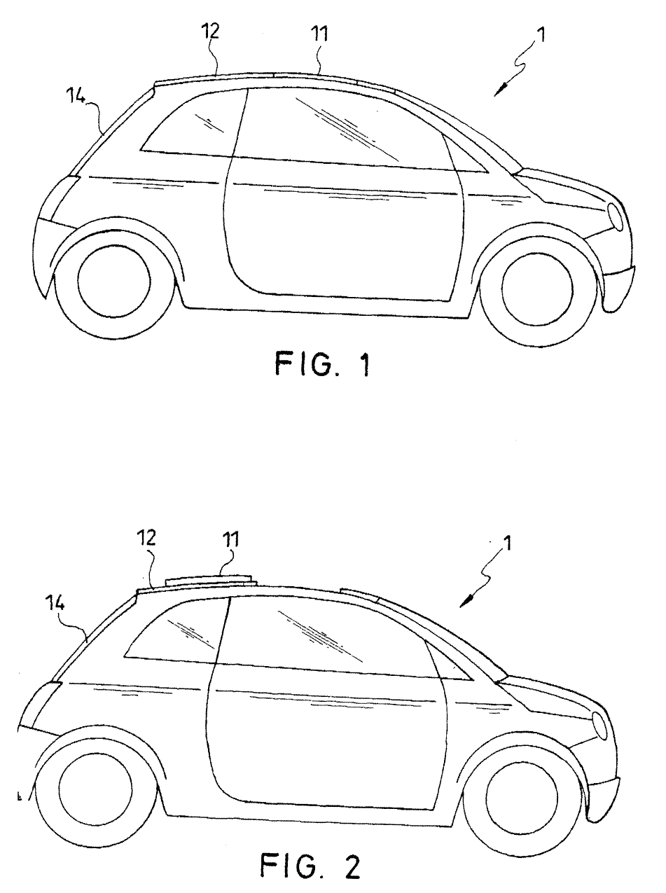

FIG. 1 shows, in a side view, a first exemplary embodiment of a vehicle with a convertible vehicle roof in the closed position;

FIG. 2 shows the vehicle in a side view, with the vehicle roof being set into a partial opening position;

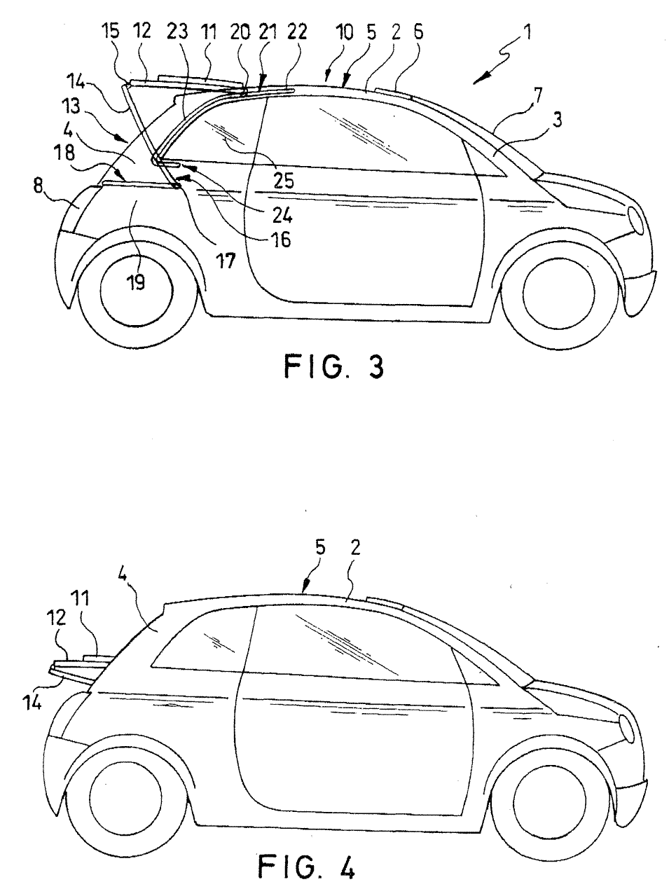

FIG. 3 shows the vehicle in a side view, with the vehicle roof being arranged in an intermediate position during the opening operation;

FIG. 4 shows the vehicle in a side view, with the vehicle roof being completely opened and stowed over a tailgate;

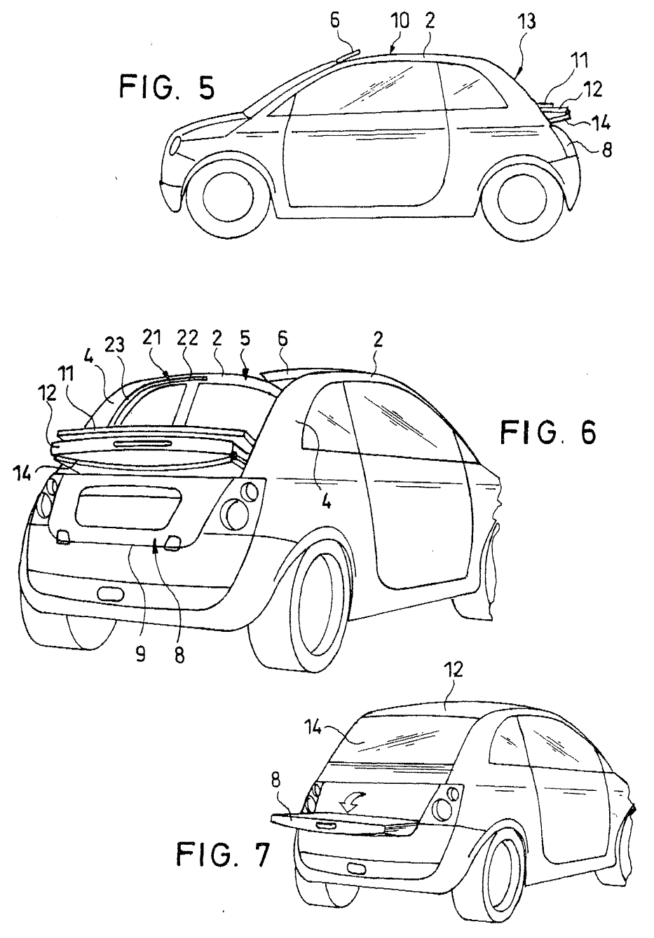

FIG. 5 shows the vehicle in a side view with the roof open and wind deflector deployed;

FIG. 6 shows, in a perspective rear view, the vehicle with the roof open;

FIG. 7 shows, in a perspective rear view, the vehicle with the roof closed and tailgate open;

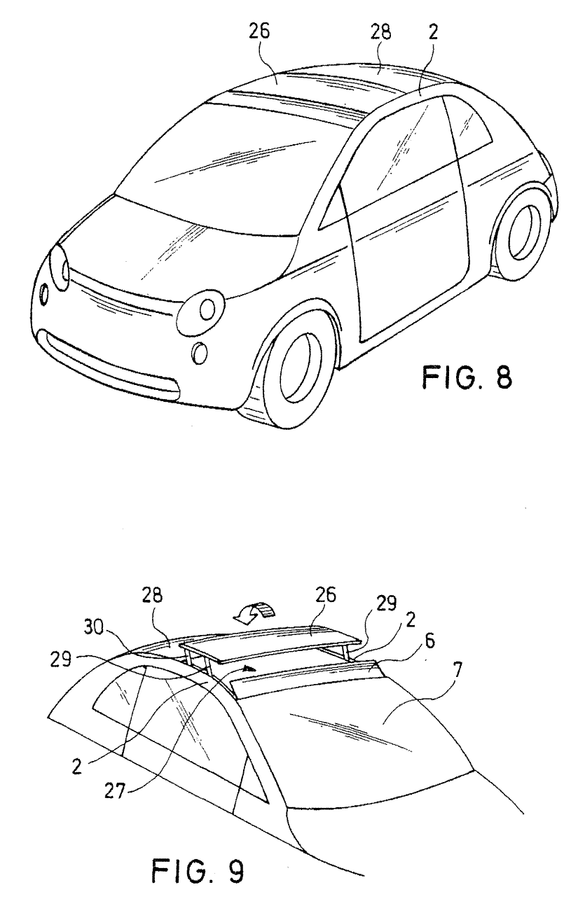

FIG. 8 shows, in a perspective front view, a second exemplary embodiment of the vehicle with the roof closed, said roof only having one roof part which can be opened; and

FIG. 9 shows, in a perspective front view, the vehicle according to FIG. 8 during the opening operation of the vehicle roof.

A vehicle 1, a four- or five-seater saloon in the exemplary embodiment, has a fixed roof structure with lateral roof longitudinal struts 2 which are fixed on the vehicle body, adjoin the A-pillars 3 at the front and merge at the rear into the C-pillars 4 or into comparable vehicle components which take on the function thereof. A roof opening 5 extends between the two roof longitudinal struts 2 and the C-pillars 4 from a deployable wind deflector 6 above a windshield 7 to the rear as far as a tailgate or trunk flap 8 which is coupled at its lower edge 9 to the vehicle body and, for opening, can be pivoted open to the rear and outward (FIG. 7). The roof opening 5 can either be closed by an openable vehicle roof (see FIG. 1) or can be at least partially exposed (FIG. 2) or entirely exposed (FIGS. 4-6).

In order to cover a front, upper section 10 of the roof opening 5, the openable vehicle roof contains a front roof part 11 and a rear roof part 12 and, in order to cover a rear section 13 of the roof opening 5, contains a rear part 14. The front roof part 11 is mounted movably on the rear roof part 12 and can be shifted from its closed position (FIG. 1) onto the rear roof part 12 into an open position (FIG. 2). The mounting of the front roof part 11 on the rear roof part 12 takes place on both sides, for example by means of a respective four-bar linkage, and therefore the front roof part 11 can be shifted onto the rear roof part 12 in a unidirectional pivoting-out movement.

The rear roof part 12 is connected to the rear part 14 by means of a pivot bearing and can be pivoted relative to said rear part about a transverse pivot axis 15.

The rear part 14 is mounted in the region of its lower edge 16 in a manner such that it can pivot relative to the vehicle body about a pivot axis 17 running in the transverse direction and in a manner such that it can be moved in a translatory manner. The mounting of the rear part 14 on the vehicle body takes place on both sides by means of a bearing means which is held displaceably on a respective, lateral, rear guide track 18 and permits the pivoting of the rear part 14 in relation to the guide track 18. The lateral, rear guide track 18 runs in the longitudinal direction of the vehicle on the inner side of a rear, lateral vehicle structure 19 essentially in a horizontal plane approximately level with the upper edge of the tailgate 8.

The rear roof part 12 is mounted displaceably on both sides, in particular in the region of its front edge, on a respective lateral, front guide track 21 by means of a bearing means 20 and can be displaced in a translatory manner and also pivoted relative to said front guide track 21. The lateral, front guide track 21 runs in an inclined manner or downward on a curved track in its front section 22 along the respective roof longitudinal strut 2 and in its rear section 23 on the inner side of the C-pillar 4 or a comparable component and finally merges into a forwardly directed, lower end section 24 which is arranged above the rear guide track 18 and runs, for example, below a lower edge of a rear side window 25.

The bearing means of the rear roof part 12 and also the bearing means of the rear part 14 are connected to a respective driving device, for example via driving cables, and are movable along the respective guide tracks 18 and 21.

When the roof is closed (FIG. 1), the two roof parts 11 and 12 and the rear part 14 form a closed roof surface between the wind deflector 6 and the tailgate 8. The rear part 14, which, for example, contains a rear window, is therefore also assigned to the convertible roof.

In order to open the vehicle roof, the front roof part 11 is pivoted from its closed position to the rear over the rear roof part 12 (FIG. 2), for example by means of a drive (not illustrated) which acts on the four-bar linkage mounting. This position of the roof can also be used in the driving mode and in order to ventilate the vehicle interior. In principle, the front roof part 11 can also be mounted on the rear roof part 12 by means of a gliding or sliding mounting and, given an appropriate mounting, can also be shifted into or under the rear roof part 12.

In order to completely open the vehicle roof, the rear roof part 12 is shifted to the rear by means of its driving device along the front section 22 of the front guide track 21 via the intermediate position illustrated in FIG. 3. At the same time or offset in terms of time, the rear part 14 is shifted to the front by means of its driving device on the rear guide track 18 toward the front end position of its bearing means. In the process, the rear part 14 pivots to the rear from its forwardly inclined position when the roof is closed such that it forms an acute angle with the rear roof part 12.

Upon further opening of the vehicle roof, the rear roof part 12 is moved downward along the downwardly running rear section 23 of the front guide track 21 until its bearing means 20 arrives at the transition to the forwardly leading end section 24 of the front guide track 21. The rear roof part 12 is thereby pivoted toward the folded-over rear part 14 and the two parts now lie approximately horizontally one above the other. Subsequently, the package comprising the rear part 14 located at the bottom, the rear roof part 12 pivoted over it and the front roof part 11 arranged thereon is moved by means of the two driving devices along the two guides, i.e. the front section of the rear guide 18 and the end section 24 of the front guide 21, into a final stowage position which is shifted forward into the vehicle and in which the roof package protrudes less far to the rear at the rear of the vehicle and, in particular, remains within the longitudinal extent of the vehicle. The tailgate 8 can continue to be opened, and therefore the loading space located therebelow is accessible even when the roof is stowed.

In order to close the roof, the roof parts and rear parts 11, 12 and 14 are actuated or shifted in the opposed direction of movement, with the driving devices being controlled to provide a fluid sequence of movement. The profiles of the respective guide tracks 18 and 21 are illustrated by way of example and can be adapted to the requirements for different types of vehicle and different types of roof.

The lateral roof struts 2 or the roof struts 2 and the C-pillars 4 can be designed in a manner such that they can be removed from the vehicle when the roof is open. At least the rear guide track 18 and the end section 24 of the front guide track 21 then remain in a stationary manner on the vehicle body for the mounting of the stowed roof 11, 12, 14.

The front and the rear roof parts 11 and 12 can be formed as transparent, sheet-like covering parts or covers or as glass covers with corresponding frames or as mounts for bearing components.

Each bearing means contains, for example, a gliding or sliding element which is held displaceably in the guide track 18 or 21 and is mounted pivotably on a journal which is fixed on the rear part 14 or the rear roof part 12 such that the bearing means permits a translatory and a rotatory movement.

The rear roof part 11 and the rear part 14 expediently have the same length, and therefore the folded package is as compact as possible. In the case of a shorter upper roof opening, the front roof part 11 may also be omitted. Of course, different designs for different shapes of roof are also possible within the scope of the invention.

The pivoting connection between the rear roof part 11 and the rear part 14 about the transverse pivot axis 15 can take place, for example, by means of a hinge device or via joints.

In a further embodiment of the invention (see FIGS. 8 and 9), the vehicle 1 contains a roof structure with fixed roof struts 2 and a roof which has a front, movable roof part 26 or a cover for optionally opening or closing a roof opening 27, and a roof part 28 which is arranged therebehind and is fixed fixedly to the roof structure. The front roof part 26 is mounted on the respective lateral roof strut 2, for example by means of a pivot mounting in the manner of a four-bar linkage with a front link 29 and a rear link 30, and can be pivoted in a simple pivoting movement, in particular upon manual actuation, between the closed position and the open position. To lock and unlock the front roof part, a central rotary handle is provided on the inner side of the roof part 26, which rotary handle is coupled to two locking elements which are mounted movably at the edges and can be locked on both sides to a cowl or to the two roof struts 2 and can be unlocked. In the open position, the roof part 26 can likewise be fixed to lateral latching receptacles by means of the locking elements which are actuated by the handle. This roof provides a high degree of functionality and extremely simple construction of the movable roof part. The two roof parts 26 and 28 are formed, in particular, as transparent parts or as glass covers. A deployable wind deflector 6 can likewise be provided. A tailgate can be coupled in a customary manner in the region of the rear edge of the rear, fixed roof part 28.

In principle, the vehicle illustrated in the two exemplary embodiments can be preconfigured uniformly such that one of the two roofs can be fixed on the vehicle during production or retrospectively, as required.

### LIST OF REFERENCE NUMBERS

```
  1 Vehicle
  2 Roof longitudinal strut
  3 A-pillar
  4 C-pillar
  5 Roof opening
  6 Wind deflector
  7 Windshield
  8 Tailgate or trunk flap
  9 Lower edge
10 Front section
11 Front roof part
12 Rear roof part
13 Rear section
14 Rear part
15 Transverse pivot axis
16 Lower edge
17 Pivot axis
18 Rear guide track
19 Lateral vehicle structure
20 Bearing means
21 Front guide track
22 Front section
23 Rear section
24 End section
25 Side window
26 Roof part or cover
27 Roof opening
28 Roof part
29 Front link
30 Rear link
```

1. A vehicle with an openable vehicle roof which has at least one roof part and a rear part which are pivotably connected to each other and can be displaced between a closed position, in which the roof part and the rear part close a roof opening or rear opening, and a rear stowage position, in which the roof part and the rear part open up the openings and, by inner sides of the roof part and the rear part, are pivoted toward each other, comprising a front guide and a rear guide each arranged on both sides of the vehicle body, wherein the roof part is displaceably mounted on both sides in each case by a bearing on the front guide and can be displaced along the front guide between its closed position and its stowage position, and wherein the rear part is displaceably mounted on both sides in each case on the rear guide by a pivot mounting on a lower edge side, and, when the roof is closed, is arranged with its pivot mounting in a rear position on the guide and, when the roof is stowed, is arranged with its pivot mounting in a front position of the guide.

2. The vehicle as claimed in claim 1, wherein the front guide runs downwardly in its front section along a roof strut arranged laterally next to the roof opening and in its rear section on a roof pillar.

3. The vehicle as claimed in claim 1, wherein the rear guide runs essentially in a longitudinal direction of the vehicle and at a lower level in relation to the rear end of the front guide.

4. The vehicle as claimed in claim 1, wherein the front guide has, at a rear end thereof, a forwardly extending end section.

5. The vehicle as claimed in claim 1, wherein a tailgate is arranged below the closed rear part, and the stowed roof is arranged essentially horizontally above the tailgate.

6. The vehicle as claimed in claim 1, wherein the roof has an additional roof part which, when the roof is closed, is arranged in the roof opening in front of the roof part and can be shifted into a partial opening position above or below the roof part.

7. The vehicle as claimed in claim 6, wherein the additional roof part is mounted on the roof part and is shifted therewith as the roof is stowed.

8. The vehicle as claimed in claim 6, wherein the additional roof part is pivotably mounted on the roof part by a link device, or displaceably mounted by a sliding guide.

9. The vehicle as claimed in claim 1, wherein the roof part has a transparent cover or glass cover.

10. The vehicle as claimed in claim 1, wherein the roof part or its mounting on the front guide and the rear part or its pivot mounting on the rear guide can be displaced by a driving device.

11. The vehicle as claimed in claim 1, comprising a deployable wind deflector arranged in front of the roof opening.

12. The vehicle as claimed in claim 1, having a fastback or a steep back.

13. A vehicle with an openable vehicle roof which has a cover for optionally opening up or closing a roof opening, wherein the cover is mounted on lateral roof struts, which are fixed on the vehicle body, by a respective four-bar linkage in a manner such that the cover can be displaced between a closed position and an open stowage position in which the cover is pivoted over the roof section which is rearwardly adjacent to the roof opening.

14. The vehicle as claimed in claim 13, wherein the cover can be pivoted manually and can be locked in its closed position and in its stowage position by a locking device.

15. The vehicle as claimed in claim 8, wherein the additional roof part is pivotably mounted on the roof part by a four-bar linkage.

16. The vehicle as claimed in claim 6, wherein the additional roof part has a transparent cover or glass cover.
